(19) United States
(12) Patent Application Publication
(10) Pub. No.: US 2006/0060049 A1
(43) Pub. Date: Mar. 23, 2006

(54) Panel saw

(76) Inventor: Stanley Learnard, Brunswick, MD (US)

Correspondence Address: Dennis H. Lambert, 7000 View Park Drive, Burke, VA, 22015, US

(21) Appl. No.: 11/231,504

(22) Filed: Sep. 21, 2005

Related U.S. Application Data
(60) Provisional application No. 60/611,827, filed on Sep. 21, 2004.

(51) Int. Cl. B27B 5/18; B26D 1/18

(52) U.S. Cl. 83/485; 83/486; 83/471.2

(57) ABSTRACT

A panel saw has a frame defining a generally planar guide and support surface for large workpieces, with tool guides on the frame for supporting a cutting tool for movement along a face of the frame to perform cutting operations on a workpiece supported and guided on the frame. A supplemental frame assembly is mounted to a front lower edge of the panel saw frame, and interchangeable adjustable stops are carried by the supplemental frame assembly for engaging an edge of a workpiece supported on the panel saw to locate and position the workpiece relative to the cutting tool. A stand-off panel is removably positioned on a front face of the panel saw frame to support, guide, and locate a workpiece in a direction outwardly from the guide and support surface and closer to the cutting tool to prevent movement of the workpiece in a direction perpendicular to the guide and support surface when the cutting tool is being operated. The cutting tool is carried by a tool mounting plate carried by a tool carriage slidable on the tool guides, and workpiece hold downs are carried by the mounting plate for engaging the workpiece and pressing it against the guide and support surface to prevent movement of the workpiece in a direction perpendicular to the guide and support surface.

### REFERENCE TO RELATED APPLICATIONS

This application claims the benefit of U.S. Provisional Patent Application Ser. No. 60/611,827, filed Sep. 21, 2004.

### TECHNICAL FIELD

This invention relates to panel saws. More particularly, the invention relates to attachments and modifications to panel saws to improve performance and facilitate ease of use, especially for repetitive cuts and multiple cuts at a particular spacing.

### BACKGROUND ART

Panel saws are known in the prior art for supporting and cutting large pieces of material, such as sheets of plywood, for example. Conventional panel saws comprise a frame that typically rests on a floor surface, and presents a front face that usually is slightly inclined from vertical, i.e., leans back away from the operator. Roller supports near the bottom of the front of the frame are spaced along the length of the frame for supporting the workpiece, such as a 4×8 sheet of plywood, for example, so that the workpiece leans back against the face of the frame and can be moved longitudinally on the frame. A circular saw, router, or other tool is mounted on the frame generally centrally of its length for up and down movement relative to the frame and thus relative to a workpiece supported on the frame.

In use, a sheet of material to be cut, routed or otherwise treated is placed on the frame with the bottom edge of the workpiece resting on the rollers. If a vertical cut is to be made in the workpiece, the saw or other tool is moved along its support slides to an elevated position above the top edge of the workpiece. The workpiece is then moved longitudinally on the frame to a predetermined position for cutting a desired length or width of the workpiece from the sheet, and the tool is then turned on and moved downwardly on its slide supports to engage and cut the workpiece. Many conventional panel saws also enable the cutting tool to be positioned and held in a desired location spaced from the bottom of the frame, and oriented so that a horizontal cut or the like can be made in the workpiece as the workpiece is moved longitudinally past the tool.

The use of a panel saw frame to hold and support the work, and to hold and guide the tool, enables accurate and repetitive cuts or other operations to be made on large workpieces. To enhance these functions, conventional panel saws can be provided with measuring tapes or devices that are mounted to the panel saw frame in a position to provide an indication of the position of the workpiece, and adjustable stops can be provided for engaging an edge of the workpiece to locate and hold the workpiece in a particular position while a cut or other operation is being performed on it. Spring hold-downs also are sometimes mounted on the frame to engage thinner workpieces to hold them against the frame and prevent undesired movement or “chatter” of the workpiece as an operation is being performed on it.

While conventional panel saws greatly facilitate the ease and convenience of cutting or performing other operations on large workpieces, such as 4×8 sheets of plywood, for example, they lack sturdiness and versatility in some of the attachments, such as edge stops, hold-downs, and the like, that are provided for attachment to the panel saw to enhance its functionality.

Accordingly, there is need for a panel saw that has performance-enhancing attachments that are sturdy and versatile in their use.

### DISCLOSURE OF THE INVENTION

The present invention comprises a panel saw having sturdy and versatile performance-enhancing attachments. In particular, according to one aspect of the invention a supplemental frame structure is mounted to a lower portion of a conventional panel saw frame for selectively supporting different types of edge stops upstream and/or downstream of the tool, and for supporting a measuring tape in a position closer to the operator and in a position to cooperate with the edge stops. The different types of edge stops include heavy duty pivoting edge stops that are pivoted into position behind the trailing edge of large heavy workpieces, and lighter duty gravity or spring operated edge stops that automatically move into position behind the trailing edge of smaller and lighter workpieces as the workpiece is advanced past the stops. These two types of edge stops are readily substituted on the supplemental frame when desired, and the heavy duty edge stops in particular may be positioned upstream and/or downstream of the tool.

In accordance with another aspect of the invention, a removable stand-off panel is provided for placement against the face of a conventional panel saw frame for locating thin workpieces closer to the tool. In one embodiment, this stand-off panel includes a plurality of recessed channel members that carry adjustable edge stops for engaging an edge of a workpiece supported on the panel saw frame, to either accurately locate the workpiece for repetitive operations or to hold the workpiece against undesired movement while an operation is being performed on it.

In accordance with a further aspect of the invention, manual and/or spring operated hold downs are mounted on the tool carriage to engage and hold the workpiece against the frame while an operation is being performed on the workpiece by the tool. In a preferred embodiment, a hold down is provided on each side of the tool, with one hold down additionally located to contact the work in advance of the tool, and the other hold down located to contact the work after it is contacted by the tool.

In accordance with a still further aspect of the invention, a piece of wood or similar material is placed in the channel behind the path of movement of the tool, to provide a back support for the work in that area.

### BRIEF DESCRIPTION OF THE DRAWINGS

The foregoing, as well as other objects and advantages of the invention, will become apparent from the following detailed description when taken in conjunction with the accompanying drawings, wherein like reference characters designate like parts throughout the several views, and wherein:

FIG. 1 is a top, front perspective view of a conventional panel saw.

FIG. 2 is a top, front perspective view of a panel saw incorporating some of the enhancement features of the invention, including the supplemental frame and one of the forms of edge stop according to the invention.

FIG. 3 is a fragmentary front perspective view of the central portion of the panel saw of the invention, showing the wood strip that is placed in the channel behind the path of the tool to provide a back support for the workpiece.

FIG. 4 is a slightly enlarged, fragmentary, front perspective view of the panel saw of the invention, showing the heavy duty edge stops according to one aspect of the invention mounted to the supplemental frame and pivoted to an up position, and also showing the wood strip to support the work behind the tool, and one form of spring hold down on the tool carriage.

FIG. 5 is a fragmentary front perspective view of the panel saw of the invention, showing an alternate edge stop arrangement supported on the supplemental frame, and showing a stand-off panel in place, with a thin workpiece supported on the assembly.

FIG. 6 is an enlarged, fragmentary, side perspective view looking toward the right hand side of a lower end portion of the panel saw of FIG. 5, depicting further details of a first form of mounting assembly for the supplemental frame.

FIG. 7 is an enlarged fragmentary perspective view of an opposite lower end portion of the panel saw of FIGS. 5 and 6, depicting additional details of the first form of mounting assembly for the supplemental frame.

FIG. 8 is an enlarged fragmentary perspective view of a lower edge portion of the panel saw of FIGS. 5 and 6, depicting an alternate form of mounting assembly for mounting the supplemental frame to the panel saw frame, wherein the mounting bracket is attached to the rear of the panel saw base panel.

FIG. 9 is an enlarged fragmentary rear perspective view of a lower edge portion of the panel saw of FIG. 8, showing how the mounting bracket is attached behind the panel saw.

FIG. 10 is an enlarged fragmentary perspective view of a lower end portion of a panel saw having a kick plate at its bottom edge, and showing how the supplemental frame is connected through a mounting bracket attached to the face of the kick plate.

FIG. 11 is a fragmentary front perspective view of the panel saw of the invention, with the edge stop assembly removed from the supplemental frame, and a stand-off panel in place, and showing a rigidifying brace extended between the supplemental frame and one of the tool carriage slide supports.

FIG. 12 is an enlarged fragmentary view of the area circled in FIG. 11.

FIG. 13 is a top, front perspective view similar to FIG. 2, showing the panel saw of the invention with a stand-off panel supported on that side of the panel saw frame upstream of the tool.

FIG. 14 is an enlarged fragmentary sectional view taken along line 14-14 in FIG. 13, of one of the edge stops and channel members carried on the stand-off panel.

FIG. 15 is an enlarged, fragmentary, partially exploded perspective view of a portion of the stand-off panel of FIG. 13, showing details of the channel member, edge stop and associated fasteners.

FIG. 16 is a greatly enlarged, fragmentary, top perspective view of a portion of the heavy duty edge stop assembly according to one form of the invention, with the edge stop shown pivoted into position behind the trailing edge of the workpiece.

FIG. 17 is an enlarged fragmentary perspective view of the heavy duty edge stop assembly of FIG. 16 removed from the supplemental frame, showing one of the edge stops in an upwardly pivoted position and adjacent edge stops in a downwardly pivoted position.

FIG. 18 is a top view of a portion of the guide channel and edge stop of FIG. 16.

FIG. 19 is a fragmentary perspective view of an end of the panel saw opposite that shown in FIGS. 4 and 5, showing an edge stop mounted on the supplemental frame at that end of the panel saw.

FIG. 20 is a slightly enlarged, fragmentary top perspective view of a portion of the panel saw with an alternate form of stand-off panel and associated edge stops shown in position cooperating with a workpiece on the saw, and an alternate, light duty edge stop assembly mounted on the supplemental frame.

FIG. 21 is a greatly enlarged, fragmentary end perspective view of the edge stop assembly of FIG. 20.

FIG. 22 is an enlarged fragmentary perspective view of the edge stop assembly of FIG. 21, showing the stop pivoted part way into operative position.

FIG. 23 is a greatly enlarged, fragmentary front perspective view of the tool carriage, tool mounting plate, associated carriage slides, and a first form of spring loaded hold down carried by the tool mounting plate, wherein the tool shown in this figure is a router.

FIG. 24 is a fragmentary front perspective view of the tool carriage and associated slides, with the tool mounting plate and tool removed from the carriage.

FIG. 25 is a perspective view of a tool mounting plate with a circular saw mounted to it, shown removed from the tool carriage, and showing a variation of the spring loaded hold down mounted to the plate.

FIG. 26 is a rear perspective view of the assembly shown in FIG. 25.

FIG. 27 is a top perspective view of a tool mounting plate and circular saw mounted thereon, with manually operated hold downs, showing the hold down to the right of the tool in a retracted position.

FIG. 28 is an top perspective of one side of the tool mounting plate, with the tool removed, showing the manual hold down of FIG. 27 that is positioned on the blade side of the tool.

FIG. 29 is a view similar to FIG. 27, showing the hold down in an extended, operative position.

FIG. 30 is a side view of one of the hold downs, shown removed from the mounting plate and looking from the side that would face the tool when in use.

FIG. 31 is a view of the hold down of FIG. 30, looking from the other side, or the side facing away from the tool when in use.

### DETAILED DESCRIPTION OF THE PREFERRED EMBODIMENTS

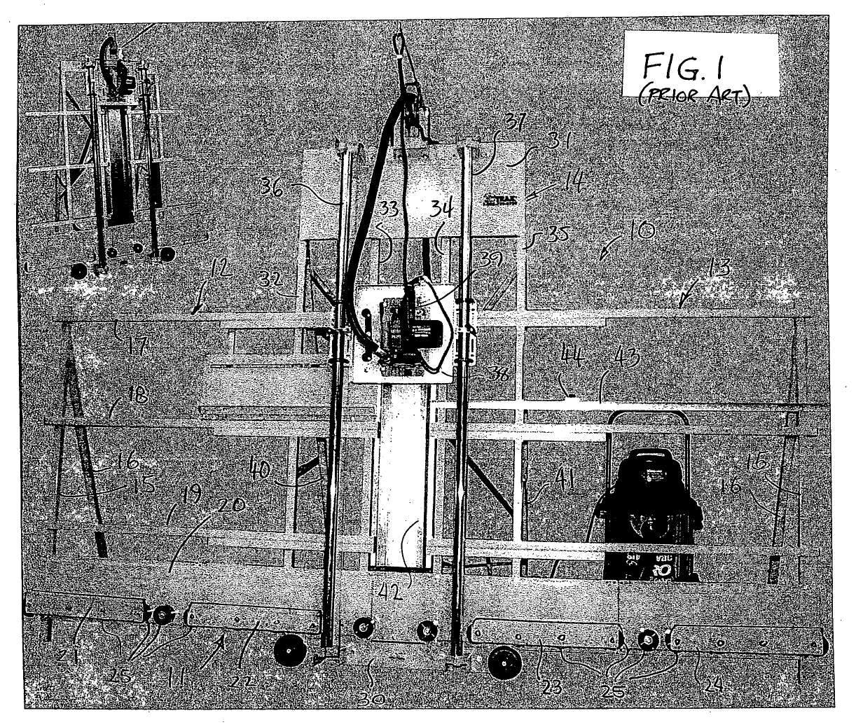

A conventional panel saw assembly is shown at 10 in FIG. 1. The panel saw comprises a frame 11 having laterally outwardly extending wings 12 and 13, and a center section 14. The wings are supported at their outer ends by angularly disposed legs 15 and 16, and comprise a plurality of parallel, horizontally extending frame bars 17, 18 and 19, and a base panel 20 with a plurality of guide plates 21, 22, 23 and 24 supported in spaced, axially aligned relationship outwardly of the panel 20. Rollers 25 are rotatably mounted along the front or face of the panel 20 at its bottom edge, with some of the rollers positioned between the guide plates and the base panel.

The center section 14 comprises a base member 30 and a top plate 31, with a plurality of generally vertically extending bars 32, 33, 34 and 35 extending between them. A pair of spaced apart, parallel tool carriage guide rods 36 and 37 extend between the base member and the top plate for supporting and guiding a tool carriage 38 having mounted thereon a suitable tool, e.g., a circular saw 39, or router or the like (not shown). Downwardly divergent support legs 40 and 41 are connected to the upper ends of the outermost vertically extending bars 32 and 35. The horizontally extending frame bars 17, 18 and 19 are interrupted between the two vertical center section bars 33 and 34, and a generally vertically extending channel member 42 is mounted in this space, behind the tool carriage, providing a clearance space for the tool as it is moved downwardly to make a cut in the workpiece. A horizontally extending bar 43 is mounted to one of the wing frames, and carries an adjustable stop 44. In addition, a tape measure (not seen) typically is positioned on top of the bar 43.

In use, a workpiece, e.g., a sheet of material (not shown) such as a sheet of plywood, fiberboard, or other material commonly cut on a panel saw is placed on the frame at one of the wings 12, with the bottom edge of the workpiece resting on the rollers 25 and retained between the guide plates 21, 22, 23 and 24 and the base panel 20, with the workpiece lying back against the face of the frame defined by the horizontally extending members 17, 18 and 19. The tool 39 is elevated to a position higher than the workpiece, which is then moved longitudinally on the rollers until it extends past the tool a predetermined distance. The tool is then turned on and moved down on its guides 36 and 37 across the sheet of material to cut it or perform some other desired operation, such as scoring or routing.

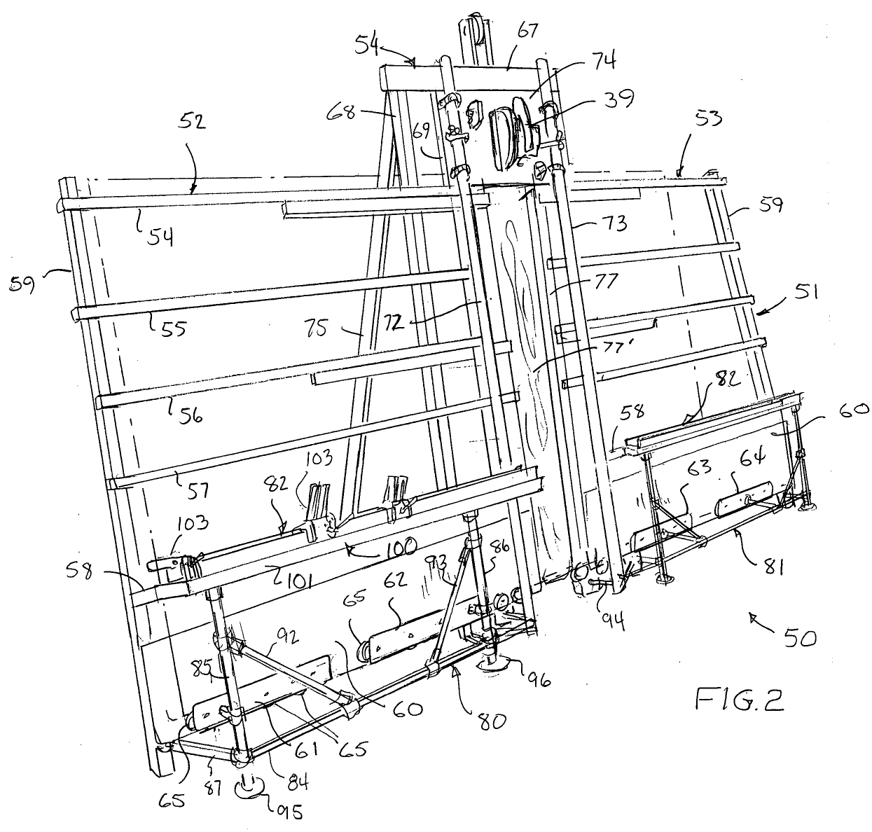

The panel saw according to the invention is indicated generally at 50 in FIG. 2 and comprises a frame structure 51 that is generally the same as that described above. That is, it comprises a pair of laterally extending wings 52 and 53 and a center section 54. The wings each include a plurality of parallel, horizontally extending frame bars 54, 55, 56, 57 and 58, generally vertically extending frame supports 59 at the outer ends of the wings, and a base panel 60 with a plurality of guide plates 61, 62, 63 and 64 supported in spaced, axially aligned relationship outwardly of the panel 60. Rollers 65 are rotatably mounted along the front or face of the panel 60 at its bottom edge, with some of the rollers positioned between the guide plates and the panel.

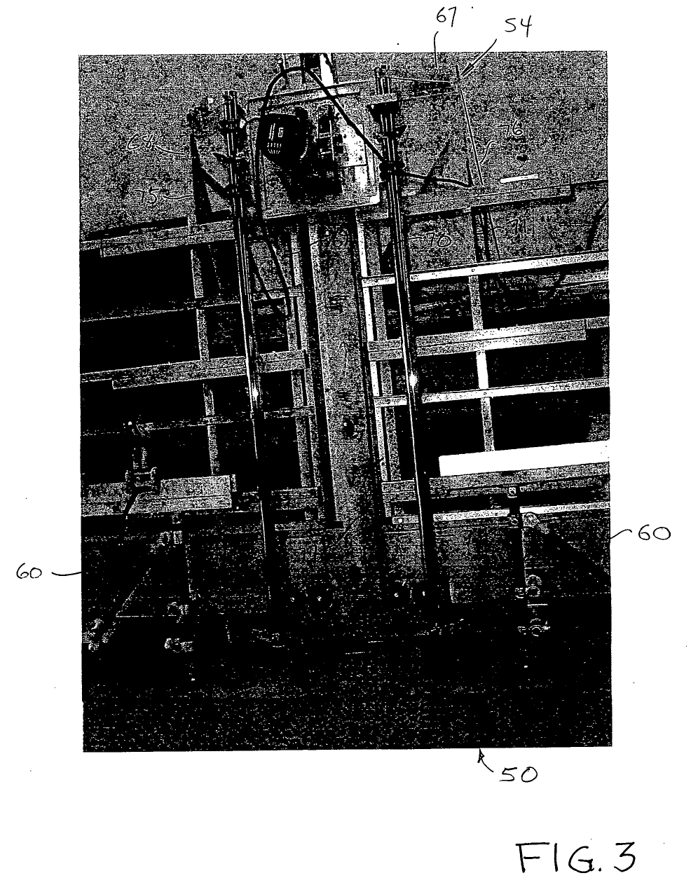

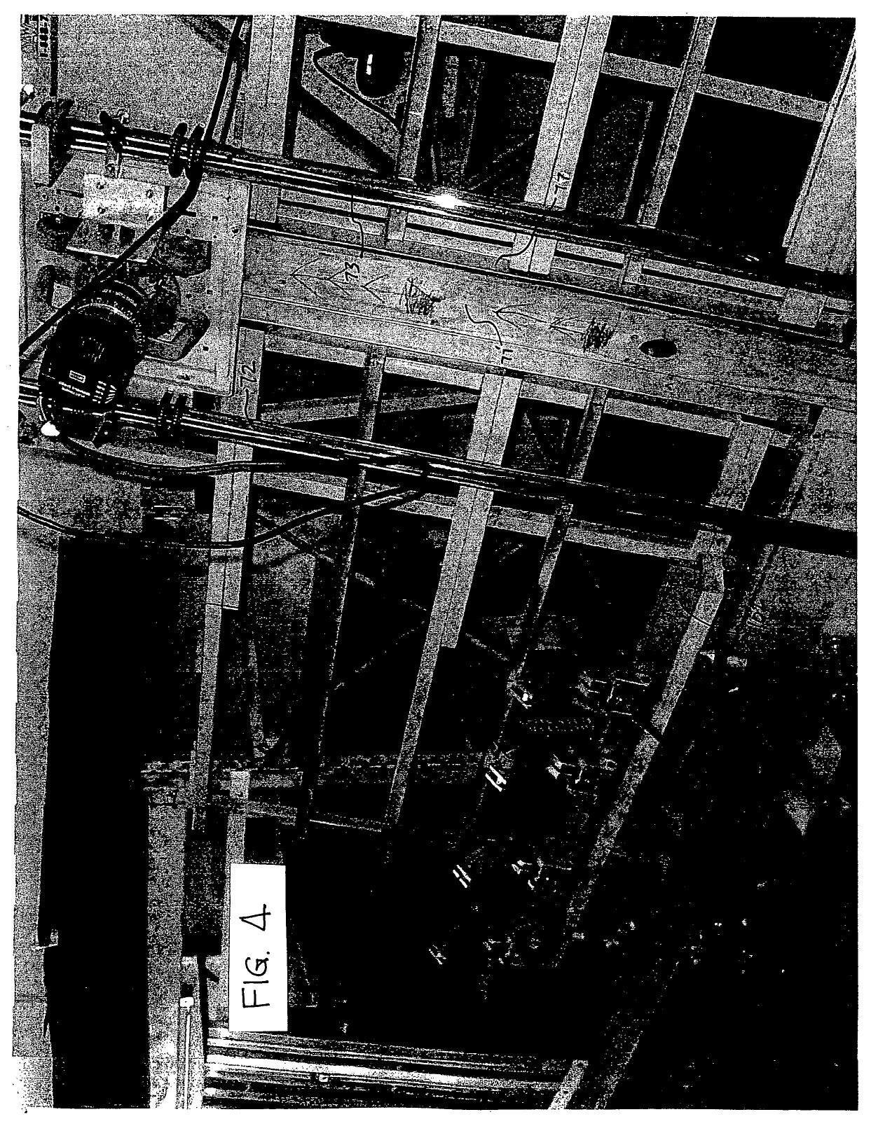

As seen best in FIG. 3, the center section 54 comprises a base member 66 and a horizontal top frame member 67, with a plurality of generally vertically extending bars 68, 69, 70 and 71 extending between them. A pair of spaced apart, parallel, tool carriage guide rods 72 and 73 extend between the base member and the top frame member for supporting and guiding a tool carriage 74 having mounted thereon a suitable tool, e.g., a circular saw 39, or router or the like (see, e.g., FIG. 4). Downwardly divergent support legs 75 and 76 are connected to the upper ends of the outermost vertically extending bars 68 and 71. The horizontally extending frame bars 54, 55, 56, 57 and 58 are interrupted between the two vertical center section bars 69 and 70, and a generally vertically extending channel member 77 is mounted in this space, behind the tool carriage.

The present invention differs from the prior art primarily in the following aspects:

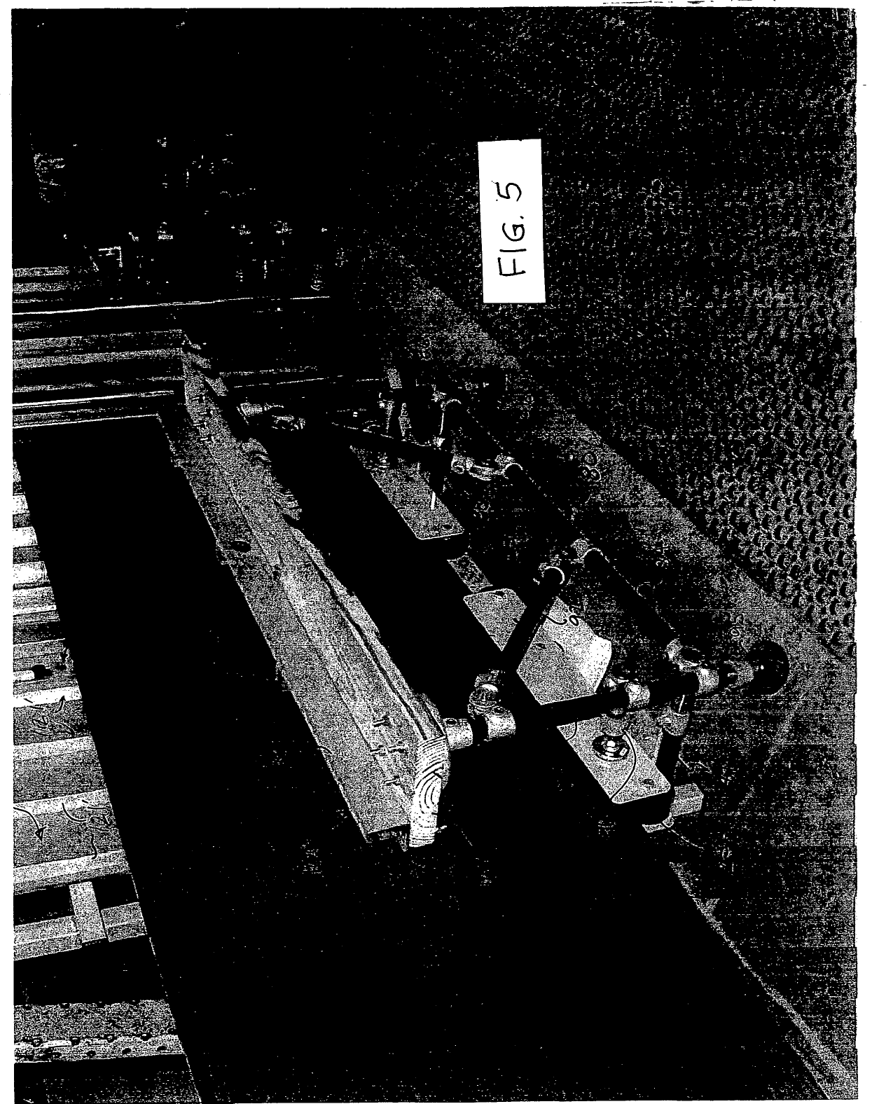

(1) supplemental frame assemblies 80 and 81 are mounted to a bottom edge portion of respective wings 52 and 53, and interchangeable edge stop assemblies 82 (see FIG. 2) and 83 (see FIG. 5) are removably mounted on the supplemental frame assemblies;

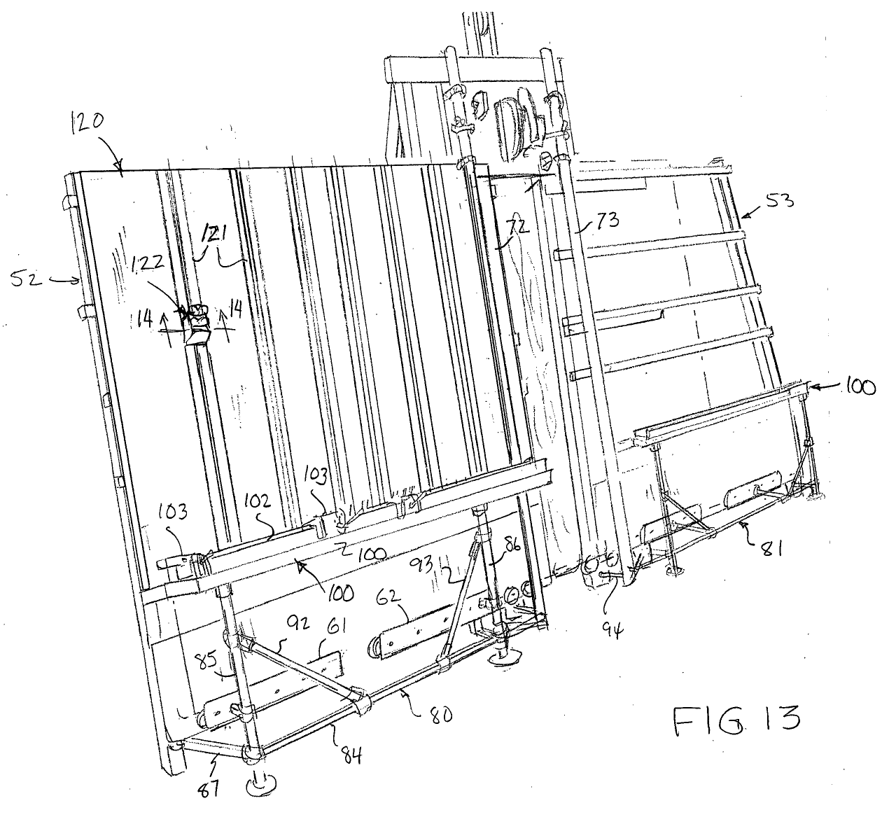

(2) a removable stand-off panel 90 (see FIGS. 5 and 13) is provided for placement on the front of one or both of the wings, to locate thin workpieces more forwardly on the panel saw frame and position them closer to the tool;

(3) channel members 100 are embedded in the face of the stand-off panel for adjustably supporting edge stops 101 to engage the upper edge of the workpiece and hold it down on the rollers;

(4) manual and/or spring loaded hold downs 110 and 120 are mounted on the tool mounting plate for engaging the workpiece and holding it in position while it is being cut; and

(5) a piece of softer material, such as a strip of wood or the like 77, is placed in the channel 77 to provide a back support for the work in the area behind the tool.

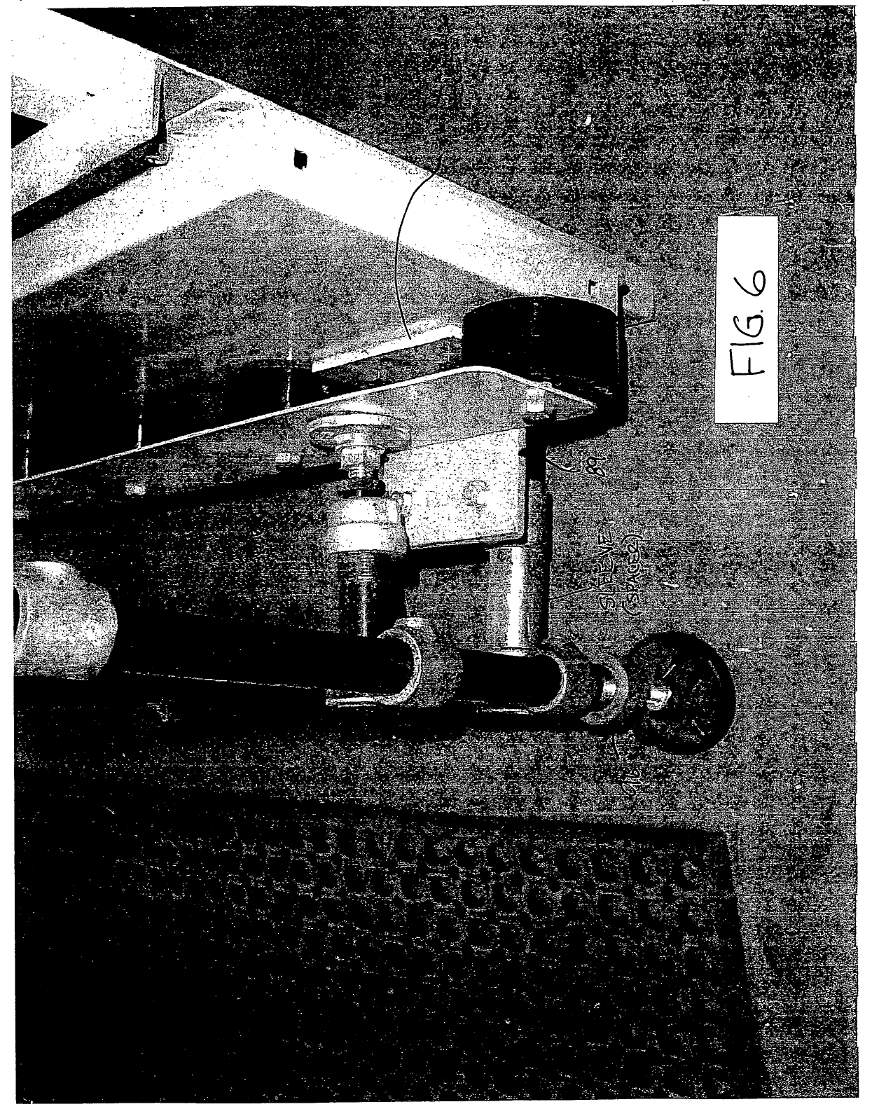

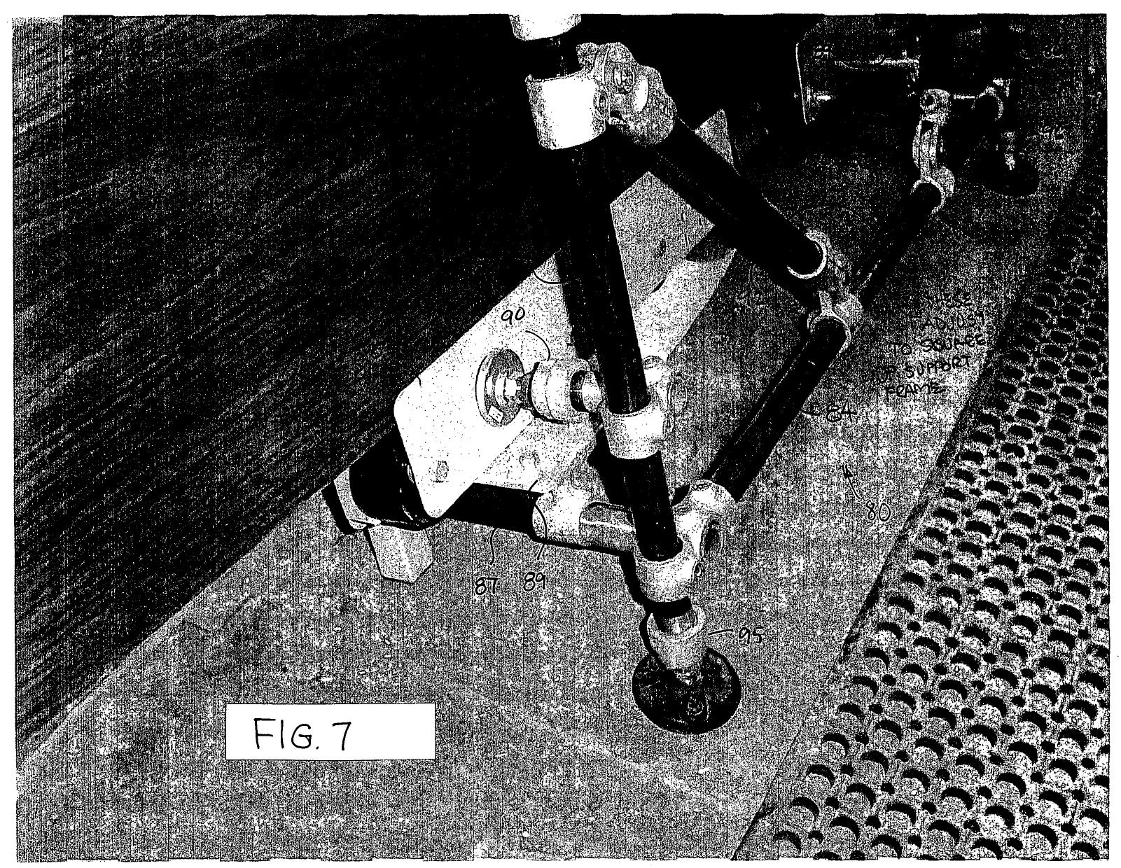

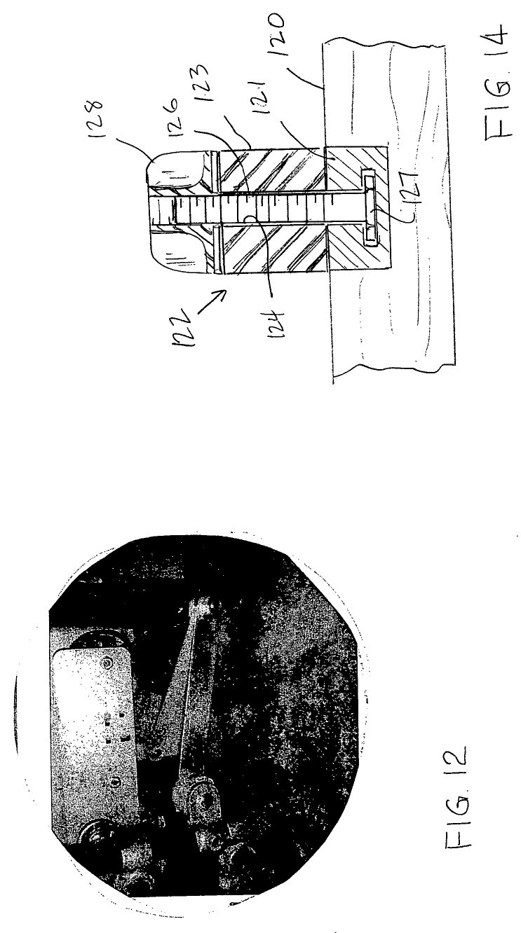

As seen best in FIGS. 2-12, the supplemental frame assemblies 80 and 81 are substantially identically constructed, except that one is mounted to the wing 52 and the other is mounted to the wing 53. Accordingly, only one (80) will be described in detail herein, it being understood that description of that one should suffice for both.

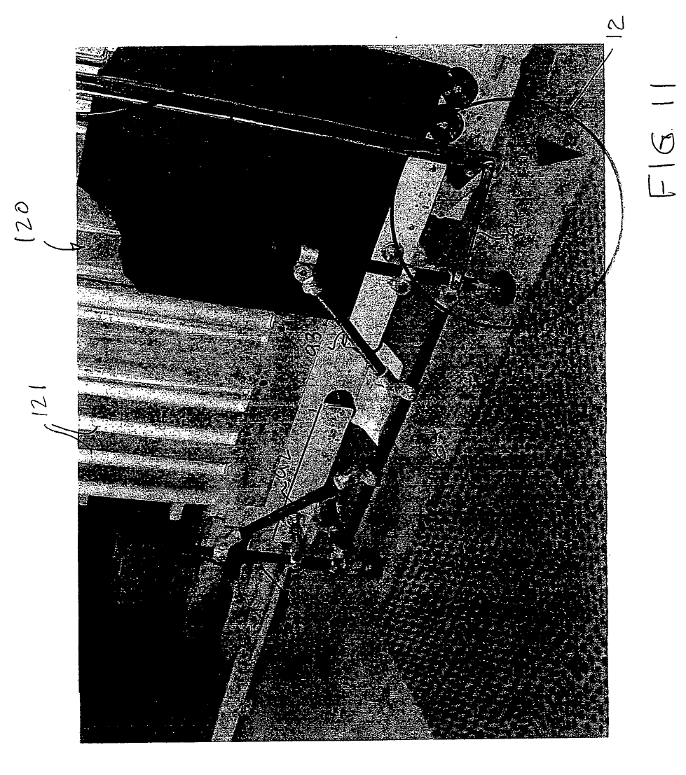

In the embodiment shown in FIGS. 2-7, the panel saw 50 does not have a kick plate on its bottom edge (see FIGS. 9, 10 and 11 for an embodiment with a kick plate). As seen in these figures, the supplemental frame assembly 80 comprises a longitudinally extending bottom frame member 84 connected between the lower ends of vertical frame members 85 and 86 that are positioned near the ends of and spaced outwardly from the panel saw frame 51. A first pair of connectors 87 and 88 extend from the lower ends of the vertical frame members 85 and 86 to a bracket 89 mounted on the lower front edge of the base panel 60 of the panel saw frame 51, and a second pair of connectors 90 and 91 extend from the vertical frame members 85 and 86, at a point spaced upwardly from the first connectors, to the respective guide plates 61 and 62. Diagonal braces 92 and 93 are connected between the bottom frame member 84 and the upper ends of the vertical frame members 85 and 86, and a stabilizing brace 94 is connected between the lower ends of the vertical frame members 85 and 86 and the lower ends of the tool carriage guide rods 72 and 73 (see FIGS. 5 and 11). Adjustable pads 95 and 96 are on the bottom ends of the vertical frame member 85 and 86 to adjust the height or vertical position of the forward side of the supplemental frame assembly, and the lengths of the first and second pairs of connectors are adjustable, as are their positions along the length of the vertical frame members. Similarly, the lengths of the diagonal braces and the positions of their connection on the bottom frame member and on the vertical frame members are adjustable. These adjustable connections enable the supplemental frame member to be squared up and matched to the exact position of the panel saw frame. The assembly 81 on the opposite side of the center section is similarly connected to the frame of wing 53.

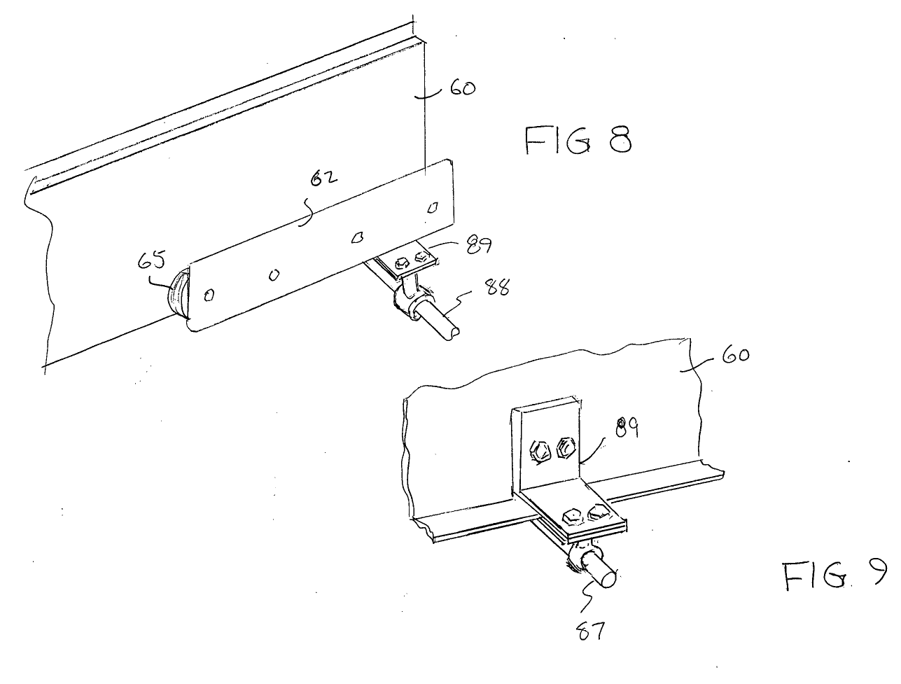

An alternate way of attaching the first pair of connectors 87 and 88 to the panel saw frame 51 is to mount the bracket 89 on the rear face of the lower edge of the base panel 60, as shown in FIGS. 8 and 9.

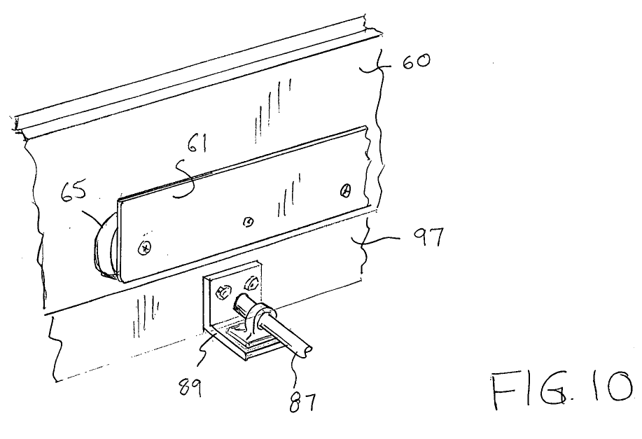

For those panel saws having a kick plate 97 along their bottom edge, the bracket 89 can be mounted to the front of the kick plate, as shown in FIG. 10.

A removable edge stop assembly 100 is connected to and supported on the upper ends of the vertical frame members 85 and 86, in close proximity to the front of the panel saw frame and extending from the outer end of the respective wing to adjacent the respective tool carriage guide rods. The edge stop assembly includes a base plate 101 that is attached to the vertical frame members, a guide channel 102 mounted on top of the base plate, and one or more pivoting edge stops 103 mounted on the guide channel for adjustable positioning along its length.

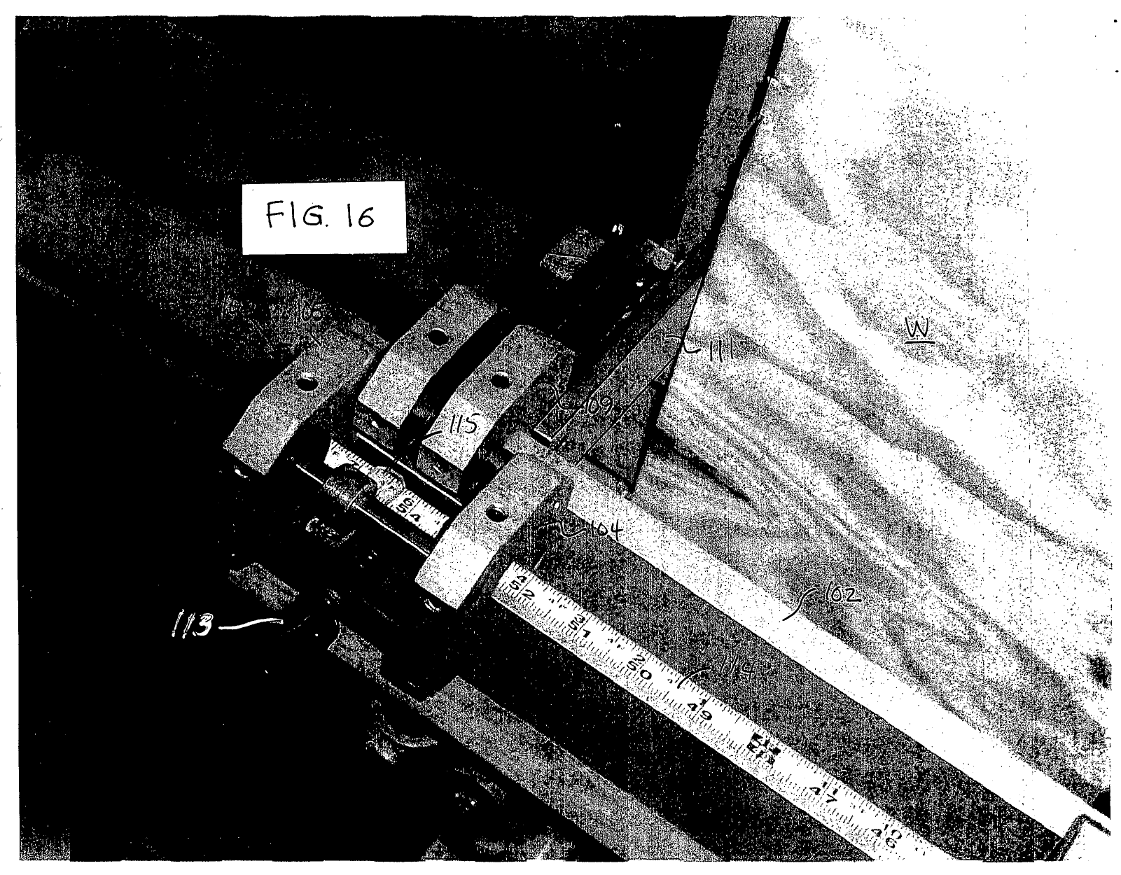

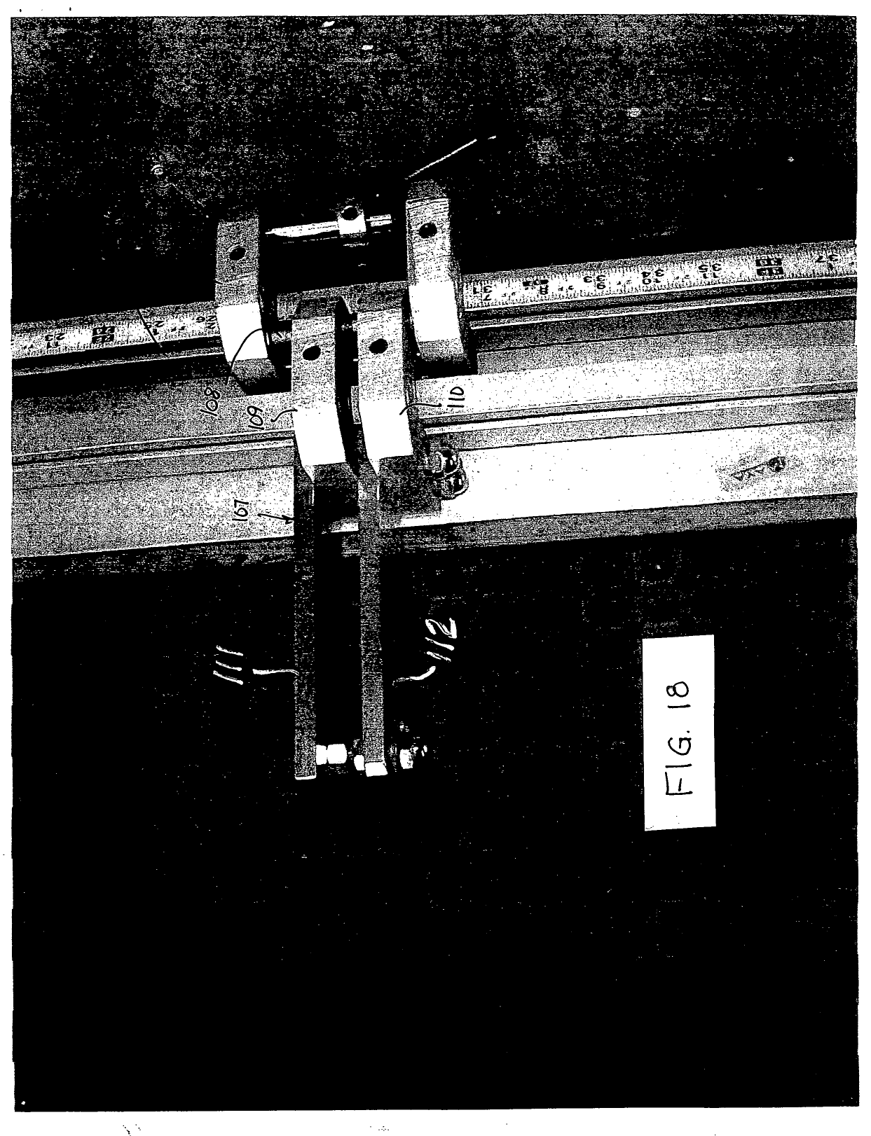

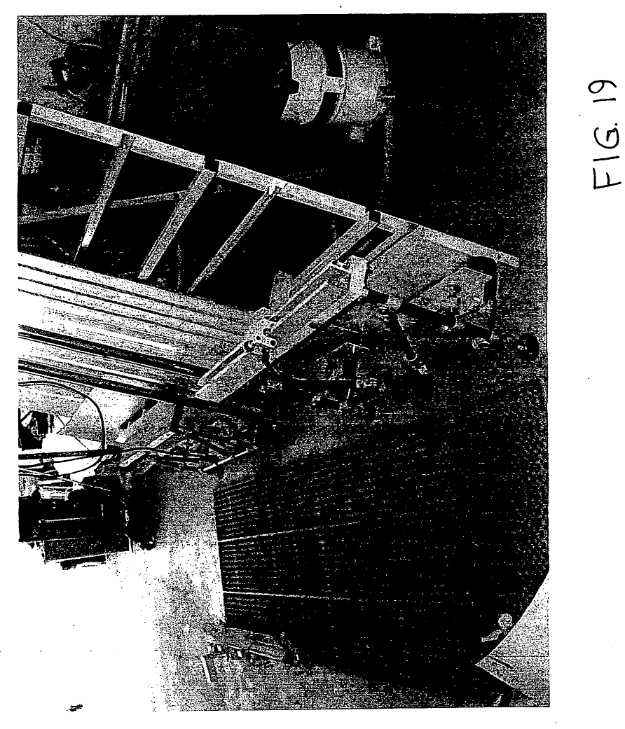

As seen in FIGS. 2, 4, and 16-19, the edge stops 103 are heavy duty units, suited for use with heavy workpieces, and each comprises a pair of inverted generally U-shaped slide brackets 104 and 105 connected together in spaced apart relationship by a plurality of pins 106, and a pivoting edge stop 107 carried on a pivot pin 108. The edge stop 107 comprises a pair of closely spaced L-shaped supports 109 and 110 mounted at one end for pivoting movement on the pivot pin, and a pair of stop bars 111 and 112 releasably attached to the other end of the supports. As seen in these figures the edge stop is located on the side of the panel saw in advance of the tool, and the stop bars 111 and 112 are positioned on the side of the supports 109 and 110 closest to the tool. However, if the edge stop is located on the opposite wing, i.e., downstream of the tool, the stop bars would be repositioned on the opposite side of the supports so that they remain on the side closest to the tool. This is to insure that the relationship between the edge stops and the measuring tape (see below) remains correct. A releasable clamp 113 is connected between the slide brackets and the guide channel for clamping the edge stop in a desired adjusted position along the length of the guide channel. A measuring tape 114 is provided on a top surface of the guide channel, and a pointer 115 is carried by the slide brackets for indicating the exact position of the edge stop. As seen in FIG. 16, the edge stop is pivoted into operative position against an edge of a sheet of material or workpiece W to positively locate the edge and thus the position of the workpiece relative to the tool.

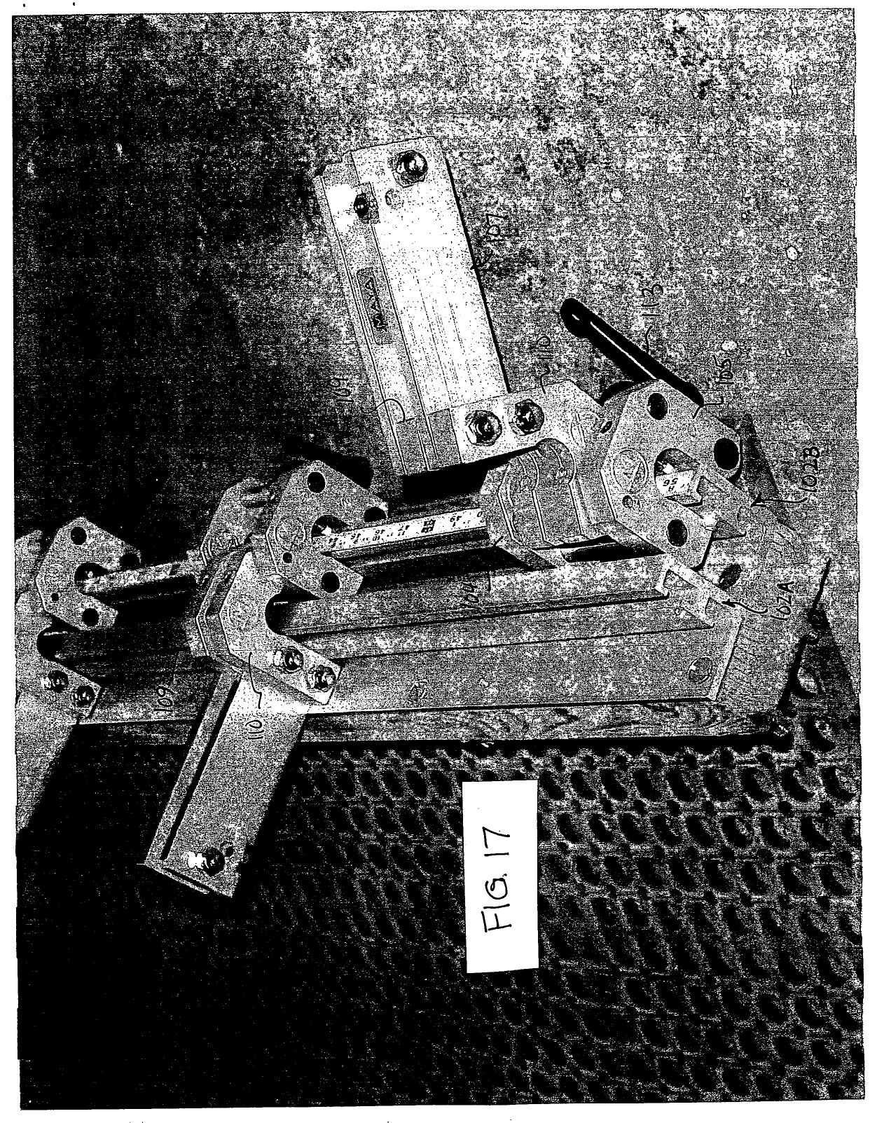

For a reason to be explained below, two identical guide channels 102A and 102B are mounted side-by-side on the base plate, as seen best in FIG. 17, with the slide brackets and associated edge stops carried by guide channel 102B. When the edge stops 103 are pivoted into operative position, the L-shaped supports 109 and 110 span the second guide channel 102A.

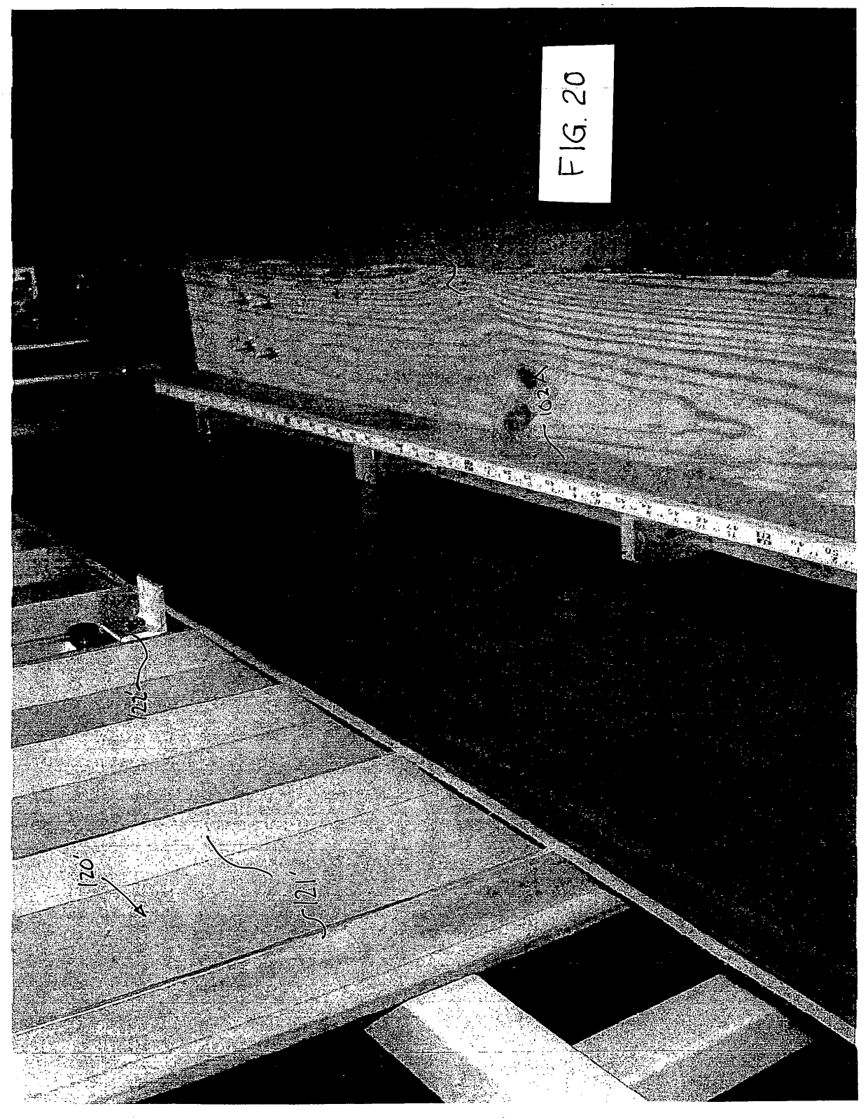

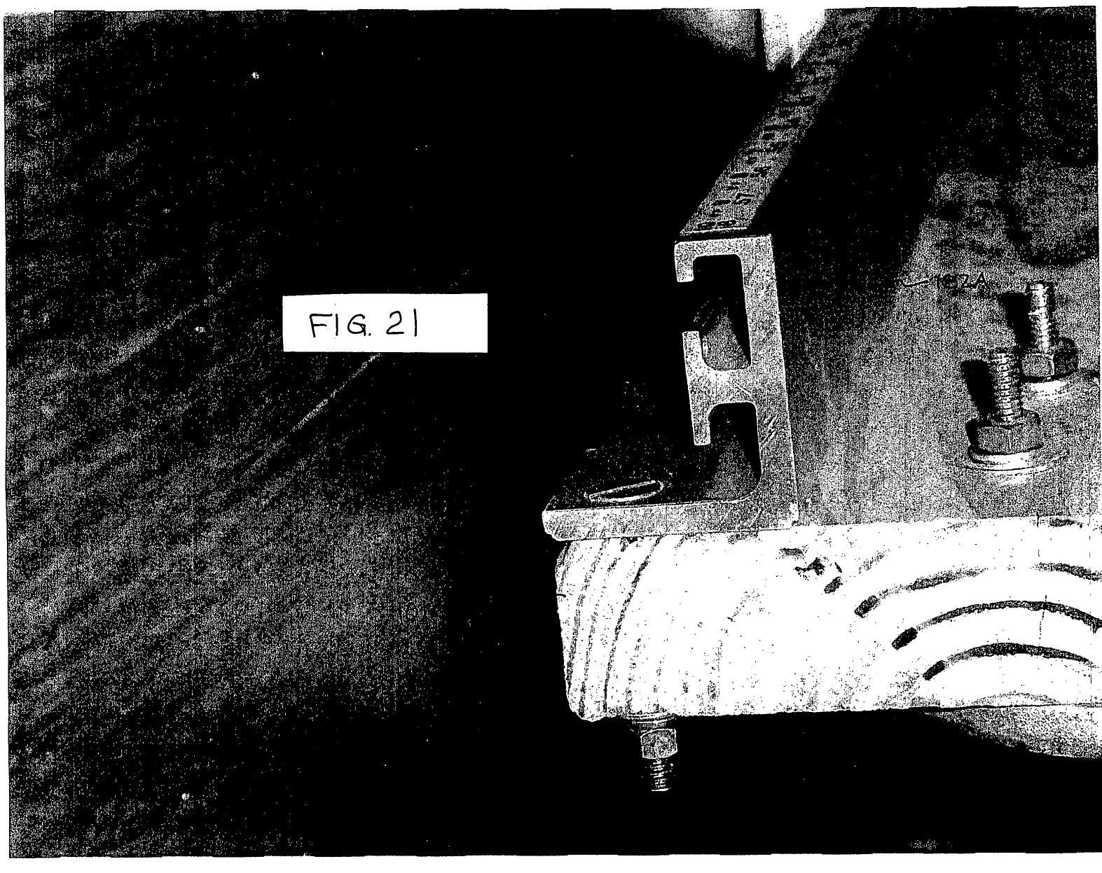

As noted above, the edge stops 103 are heavy-duty units. However, when lightweight workpieces are being handled, lighter duty edge stops 103A can be used, as shown in FIGS. 5, 20, 21 and 22. When this is desired, the guide channel 102B and its associated heavy-duty edge stops 103 are removed from the base plate 101, and the lighter duty edge stops 103A are assembled to the guide channel 102B. The edge stops 103A comprise a housing 116 that is positionable along the channel 117 in the guide channel 102B, and spring-loaded or gravity operated stop arms 118 that automatically pivot out of the housing when the trailing edge of the workpiece moves past them.

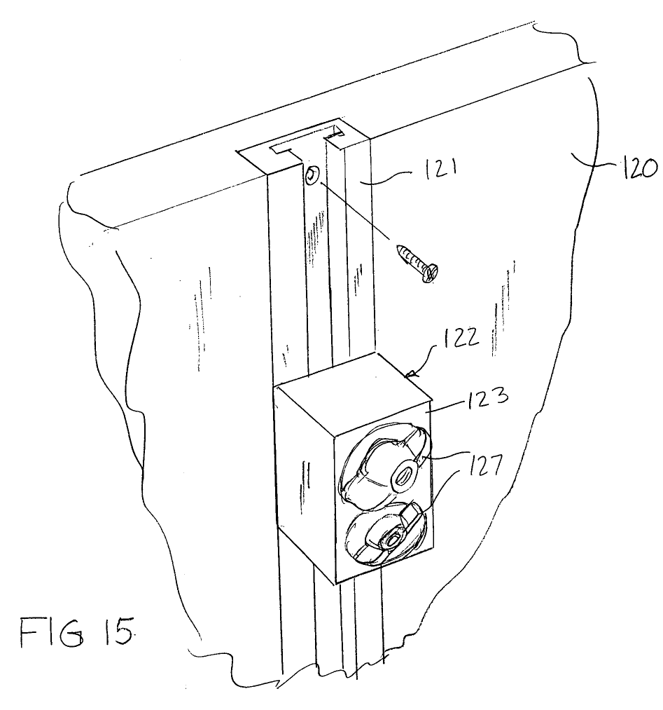

As seen best in FIG. 13, stand-off panels 120 can be positioned on the front of the wings 52 and 52 of the panel saw frame 51 to position thin workpieces more forwardly on the panel saw and closer to the tool. The stand-off panels preferably have a thickness of about 1 inch, and can include a plurality of vertically extending channels 121 recessed into the front face thereof for carrying one or more edge stops 122 that are movable along the channels to engage the upper edge of a workpiece to hold it down on the rollers. The edges stops 122 are seen best in FIGS. 14 and 15, and comprise a rectangular block 123 having a pair of holes 124 and 125 extending therethrough from the front face to the back face, with a threaded bolt 126 having a head 127 slidable in the channel 121 and a threaded nut 128 engaged on the end protruding through the face of the block.

An alternate stand-off panel 120′ is depicted in FIGS. 5, 11 and 20. In this embodiment, vertically extending members 121′ project outwardly from the face of the panel to position the workpiece closer to the edge stop means 116 and to the cutting tool, and additional guides or hold-downs 122′ are vertically positionable on the panel 120′ to engage an upper edge of a workpiece to hold it down on the rollers 25.

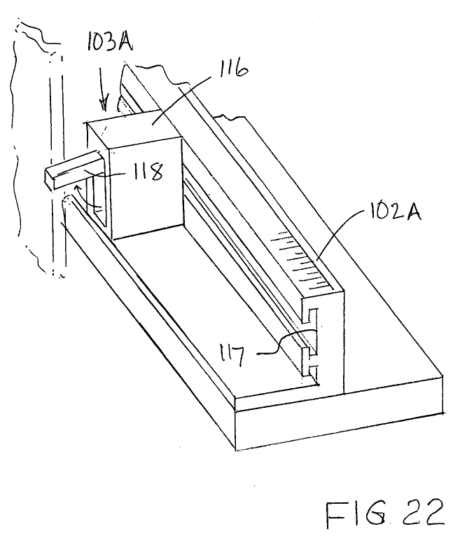

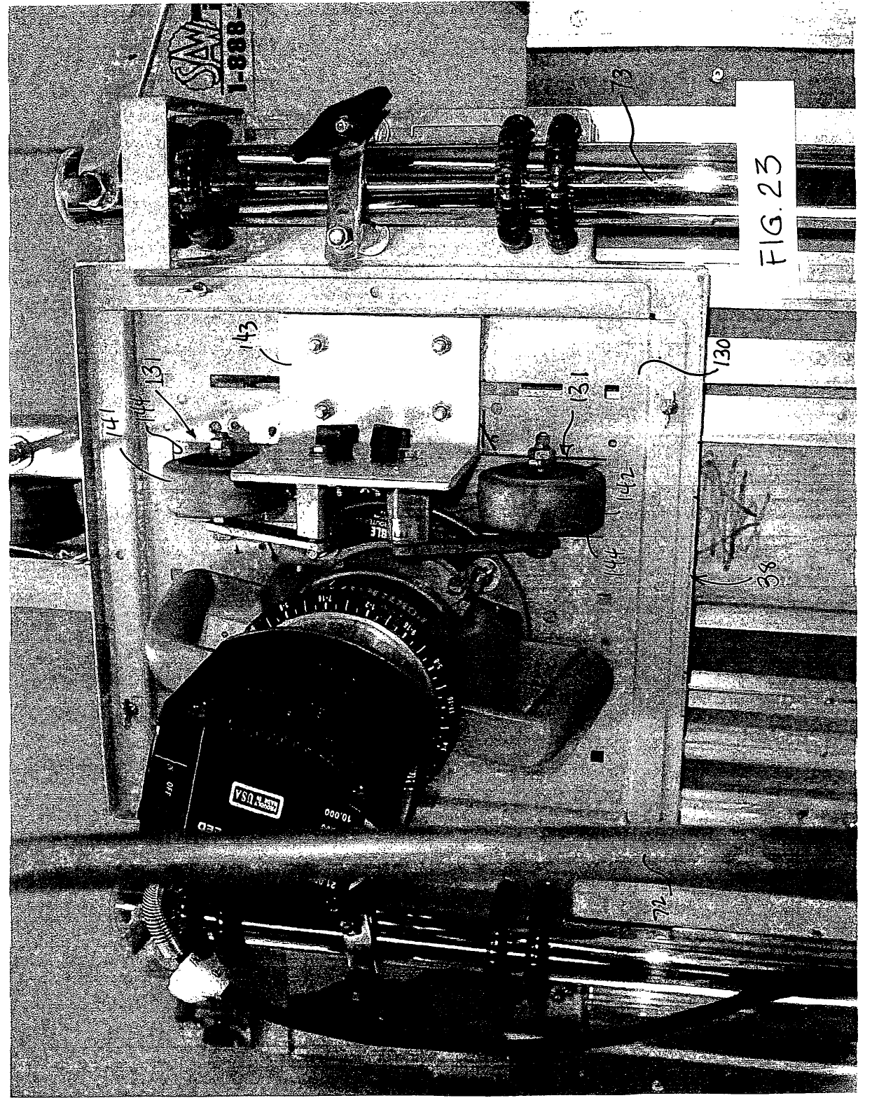

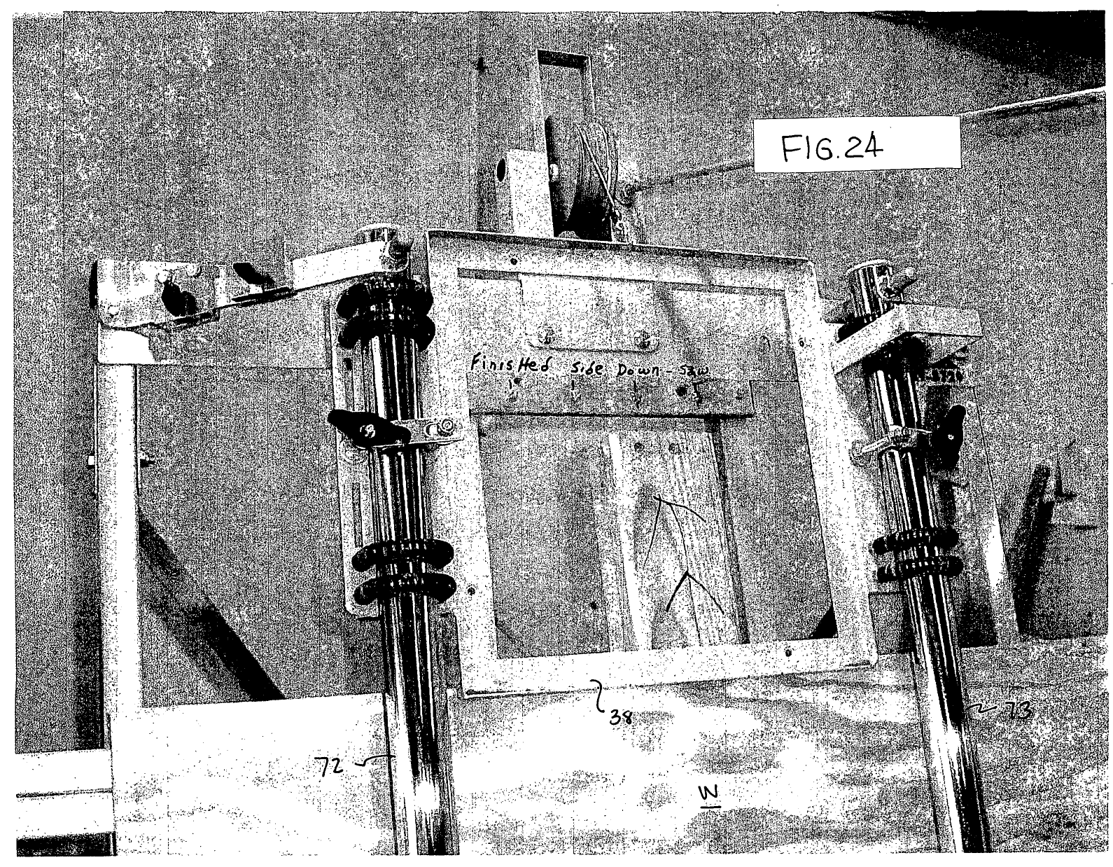

The hold-downs and modified tool mounting plate of the invention are seen best in FIGS. 23-29. The tool mounting plate 130 is a flat rectangular plate that is removably mounted to the tool carriage 38 that slides on the guide rods 72 and 73. It has various openings therein for mounting different tools, and in the invention at least one and preferably a plurality of hold-downs 131 are carried by the mounting plate for engaging the workpiece to hold it against the panel saw frame, or against the stand-off panels when they are used. In FIG. 24, the mounting plate is shown removed from the tool carriage 38.

A first type of hold down is shown in FIG. 23, and comprises at least one, and in the embodiment shown, two spring biased wheels or rollers 141 and 142 carried by an L-shaped bracket 143 attached to the mounting plate 130. The rollers project through an opening 144 in the mounting plate and press against a workpiece positioned on the panel saw to hold the workpiece against the panel saw frame and prevent undesired movement or “chatter” of the workpiece as it is being operated on by the tool.

A second type of hold down is shown in FIGS. 25 and 26, wherein a spring loaded hold-down roller 151 is carried by the mounting plate 130 on one side of the tool (saw 39 in the example shown), and a pair of manually adjustable hold-down slides 152 and 153 are carried by the mounting plate on the other side of the tool, with one of the slides 152 positioned to engage the workpiece in advance of the tool and the other slide 153 positioned to engage the workpiece following contact by the tool. The slides 152 and 153 project through respective openings 154, 155 in the mounting plate, and are carried by brackets 156 attached to the top of the mounting plate so that the slides can be clamped in different adjusted positions relative to a workpiece to accommodate workpieces of different thickness, i.e., the slides should bear against the workpiece with just sufficient pressure to prevent movement of the workpiece, but not to impede sliding movement of the hold down on the workpiece. In this regard, the slides preferably are made of neoprene, plastic or other suitable material to facilitate sliding movement of the slides against the workpiece and prevent marring of the workpiece by the slides.

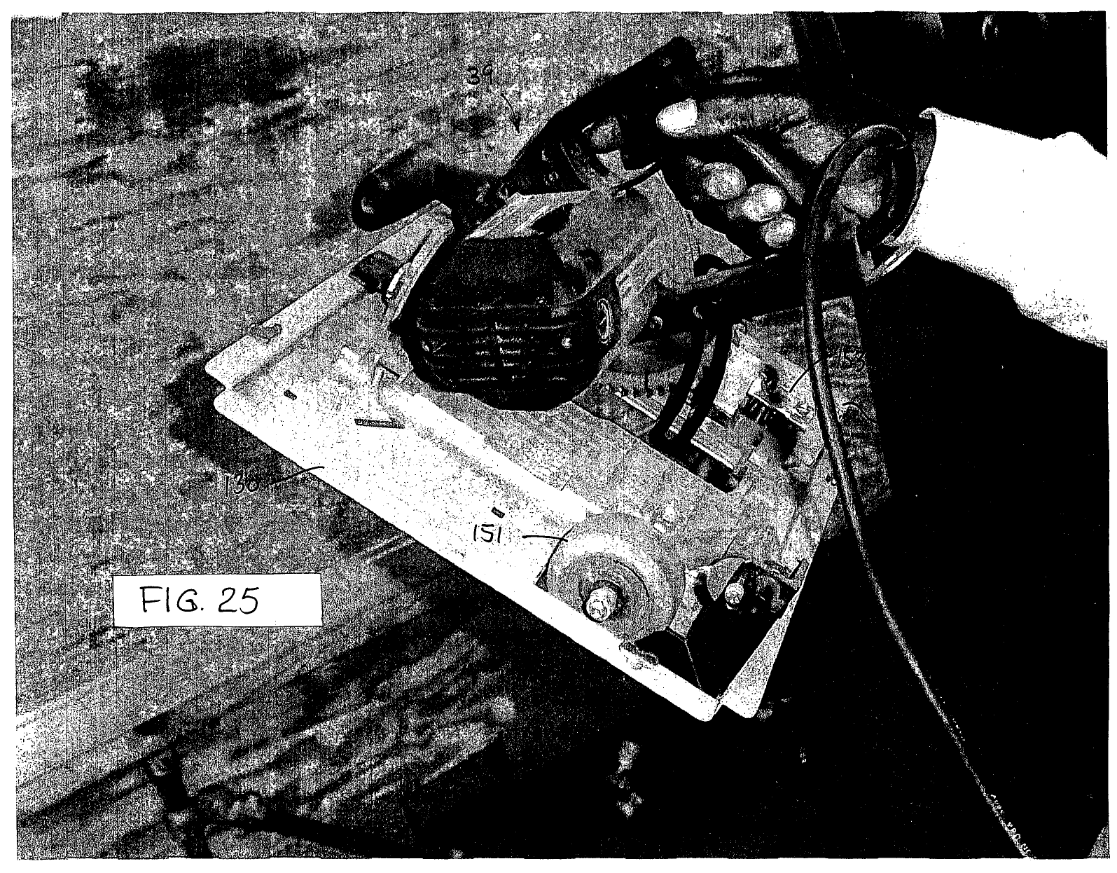

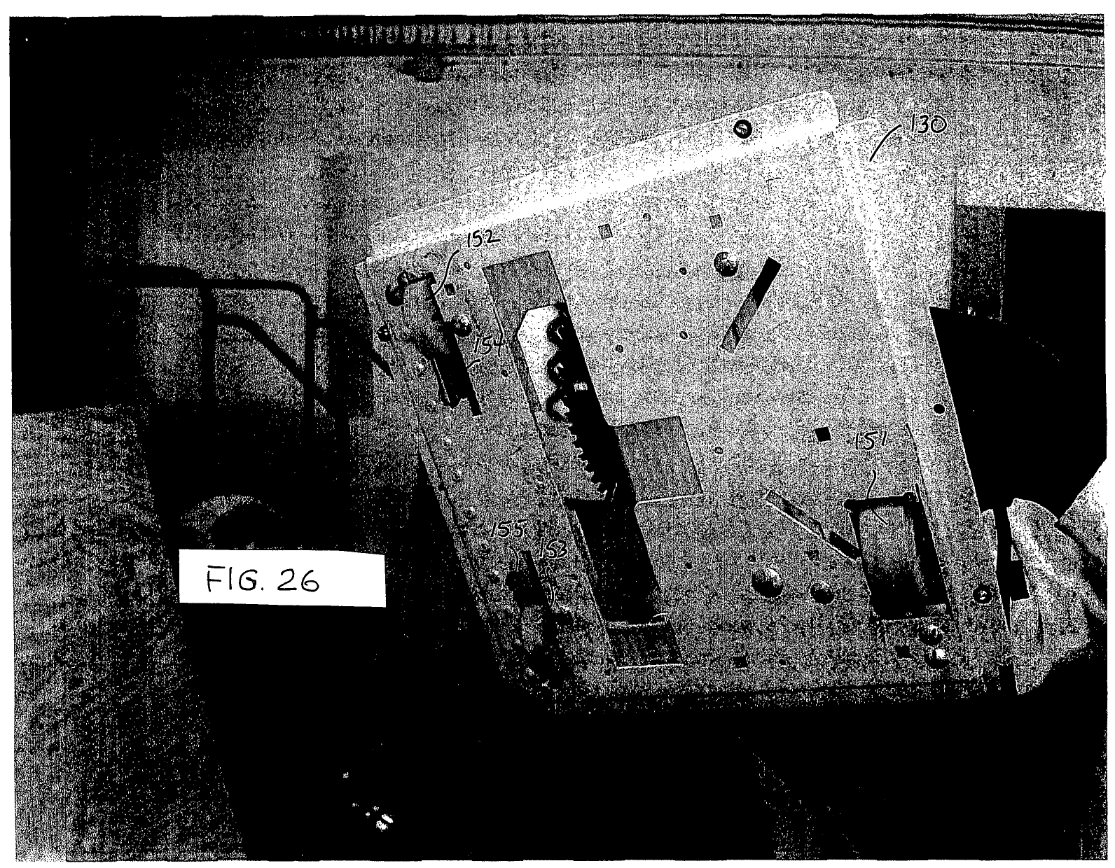

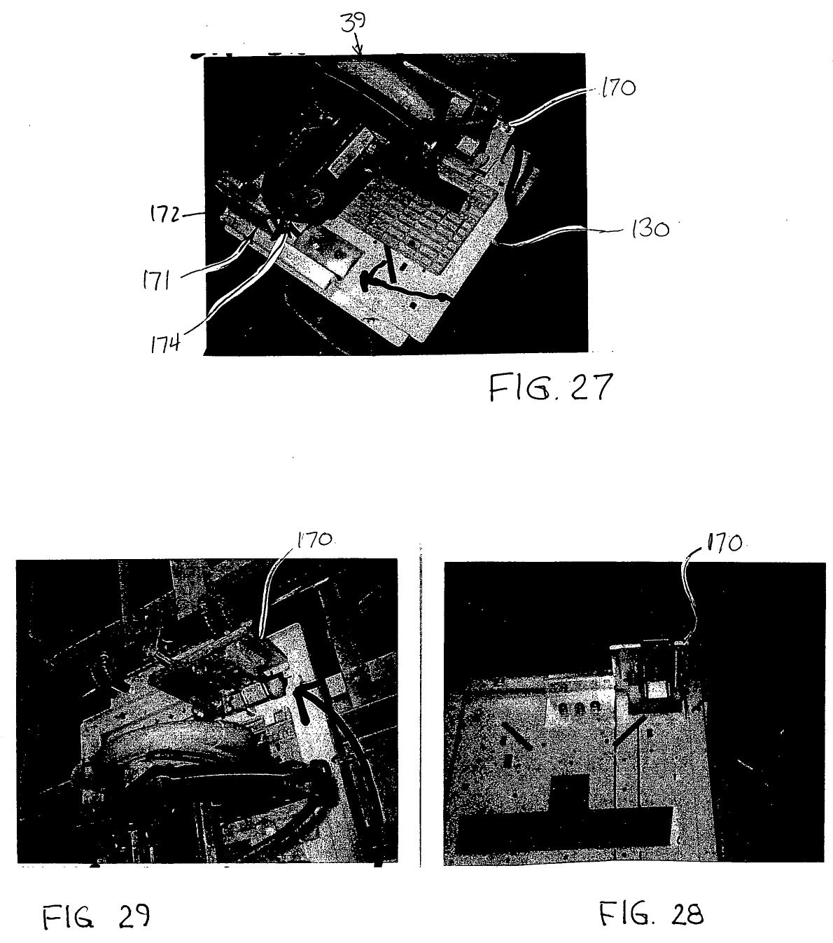

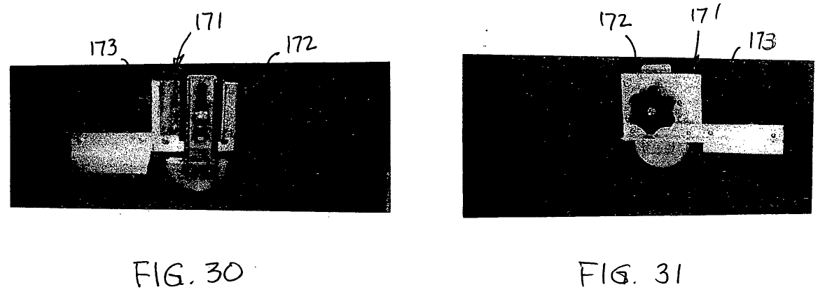

A third type of hold down is shown in FIGS. 27, 28, 29, 30 and 31, wherein a pair of manually adjustable hold-down slides 170 and 171 are attached to the mounting plate 130 on opposite sides of the tool 39, with one of the slides 170 positioned to engage the workpiece in advance of the tool, and the other slide 171 positioned to engage the workpiece following the tool. It will be noted that a portion of the bracket 172 supporting the slide 171 is recessed at 173 to avoid interference with the cooling vent 174 for the tool.

Although particular embodiments of the invention are illustrated and described in detail herein, it is to be understood that various changes and modifications may be made to the invention without departing from the spirit and intent of the invention as defined by the scope of the appended claims.

What is claimed is:

1. In a panel saw having a frame comprising a plurality of generally horizontal frame members and a plurality of generally vertical frame members defining a generally planar guide and support surface for large workpieces, said generally horizontal frame members extending in a length direction of the panel saw, and tool guide means for supporting a cutting tool for movement along a face of the frame transverse to the length direction to perform cutting operations on a workpiece supported and guided on the panel saw frame, the improvement comprising:
a supplemental frame assembly mounted to a front lower edge of the panel saw frame; and
adjustable stop means carried by the supplemental frame assembly for engaging an edge of a workpiece supported on the panel saw to locate the workpiece in the length direction of the panel saw and to position the workpiece relative to the cutting tool, whereby repetitive operations can be performed by the cutting tool on the workpiece or multiple workpieces at a predetermined spacing as determined by the positioning of the workpieces by the stop means.

2. A panel saw as claimed in claim 1, wherein:
the position of said adjustable stop means is adjustable in the length direction of the panel saw.

3. A panel saw as claimed in claim 2, wherein:
the stop means includes an edge stop that is movable between a first position out of the way of the workpiece so that the workpiece can be moved in a first direction along the panel saw frame toward the cutting tool and a second position engaged against said edge of the workpiece to prevent reverse movement of the workpiece away from the cutting tool.

4. A panel saw as claimed in claim 3, wherein:
measuring indicia are carried by the supplemental frame assembly, extending in the length direction of the panel saw; and
pointer means is carried by the stop means for cooperation with the measuring indicia to provide a visual indication to an operator of the position of the stop means and thus of the workpiece relative to the cutting tool.

5. A panel saw as claimed in claim 4, wherein:
the edge stop is pivotable between said first and second positions.

6. A panel saw as claimed in claim 5, wherein:
the adjustable stop means is releasably carried by the supplemental frame assembly so that different adjustable stop means can be quickly and easily substituted on the supplemental frame assembly.

7. A panel saw as claimed in claim 6, wherein:
said different adjustable stop means include a first, heavy duty stop means for use with large heavy workpieces, and a second, light duty stop means for use with lighter weight workpieces.

8. A panel saw as claimed in claim 7, wherein:
said first, heavy duty stop means comprises a guide channel releasably mounted to the supplemental frame assembly, at least one U-shaped slide bracket slidable on the guide channel, and said edge stop is pivotally mounted to said at least one U-shaped guide channel for pivoting movement between said first and second positions.

9. A panel saw as claimed in claim 7, wherein:
said second, light duty stop means comprises a guide channel releasably mounted to the supplemental frame assembly, a housing positionable along the guide channel, and said edge stop comprises stop arms that automatically deploy from the housing to engage said edge of the workpiece when the workpiece is advanced past the housing.

10. A panel saw as claimed in claim 1, wherein:
a stand-off panel is removably positioned on a front face of the panel saw frame to support, guide, and locate a workpiece in a direction closer to the cutting tool to prevent movement of the workpiece in a direction perpendicular to said generally planar guide and support surface when the cutting tool is being operated.

11. A panel saw as claimed in claim 10, wherein:
said stand-off panel has length and width dimensions substantially commensurate with length and width dimensions of said generally planar guide and support surface;
vertically extending guide channels are recessed into a face of the stand-off panel oriented toward an operator; and
said adjustable stop means are carried by the guide channels.

12. A panel saw as claimed in claim 11, wherein:
said adjustable stop means are adjustable along said guide channels.

13. A panel saw as claimed in claim 1, wherein:
said cutting tool includes a tool carriage slidable on said tool guide means, a tool mounting plate releasably carried by the tool carriage, and workpiece hold downs carried by the mounting plate for engaging the workpiece and pressing it against the generally planar guide and support surface to prevent movement of the workpiece in a direction perpendicular to the generally planar guide and support surface.

14. A panel saw as claimed in claim 7, wherein:
a stand-off panel is removably positioned on a front face of the panel saw frame to support, guide, and locate a workpiece in a direction closer to the cutting tool to prevent movement of the workpiece in a direction perpendicular to said generally planar guide and support surface when the cutting tool is being operated.

15. A panel saw as claimed in claim 14, wherein:
said stand-off panel has length and width dimensions substantially commensurate with length and width dimensions of said generally planar guide and support surface;
vertically extending guide channels are recessed into a face of the stand-off panel oriented toward an operator; and
said adjustable stop means are carried by the guide channels.

16. A panel saw as claimed in claim 15, wherein:
said adjustable stop means are adjustable along said guide channels.

17. A panel saw as claimed in claim 7, wherein:
said cutting tool includes a tool carriage slidable on said tool guide means, a tool mounting plate releasably carried by the tool carriage, and workpiece hold downs carried by the mounting plate for engaging the workpiece and pressing it against the generally planar guide and support surface to prevent movement of the workpiece in a direction perpendicular to the generally planar guide and support surface.

18. In a panel saw having a frame comprising a plurality of generally horizontal frame members and a plurality of generally vertical frame members defining a generally planar guide and support surface for large workpieces, said generally horizontal frame members extending in a length direction of the panel saw, and tool guide means for supporting a cutting tool for movement along a face of the frame transverse to the length direction to perform cutting operations on a workpiece supported and guided on the panel saw frame, the improvement comprising:
a stand-off panel removably positioned on a front face of the panel saw frame to support, guide, and locate a workpiece in a direction outwardly from said generally planar guide and support surface and closer to the cutting tool to prevent movement of the workpiece in a direction perpendicular to said generally planar guide and support surface when the cutting tool is being operated.

19. A panel saw as claimed in claim 18, wherein:
said stand-off panel has length and width dimensions substantially commensurate with length and width dimensions of said generally planar guide and support surface;
vertically extending guide channels are recessed into a face of the stand-off panel oriented toward an operator; and
said adjustable stop means are carried by the guide channels.

20. In a panel saw having a frame comprising a plurality of generally horizontal frame members and a plurality of generally vertical frame members defining a generally planar guide and support surface for large workpieces, said generally horizontal frame members extending in a length direction of the panel saw, and tool guide means for supporting a cutting tool for movement along a face of the frame transverse to the length direction to perform cutting operations on a workpiece supported and guided on the panel saw frame, the improvement comprising:
a tool carriage slidable on said tool guide means, a tool mounting plate releasably carried by the tool carriage, and workpiece hold downs carried by the mounting plate for engaging the workpiece and pressing it against the generally planar guide and support surface to prevent movement of the workpiece in a direction perpendicular to the generally planar guide and support surface.
